(19) United States
(12) Patent Application Publication
(10) Pub. No.: US 2025/0141122 A1
(43) Pub. Date: May 1, 2025

(54) INSULATION PIERCING SPLIT BOLT ASSEMBLY

(71) Applicant: Panduit Corp., Tinley Park, IL (US)

(72) Inventors: Rodney G. Rouleau, Manhattan, IL (US); Alfred Pierce, Bolingbrook, IL (US); Sahar Ramahi, Palos Hills, IL (US)

(73) Assignee: Panduit Corp., Tinley Park, IL (US)

(21) Appl. No.: 18/385,122

(22) Filed: Oct. 30, 2023

(51) Int. Cl. H01R 4/2408; F16B 35/02; H01R 4/30

(52) U.S. Cl. CPC H01R 4/2408; F16B 35/02; H01R 4/305

(57) ABSTRACT

A split bolt assembly for providing tap electrical connections between two conductive cables in an efficient manner.

### TECHNICAL FIELD

The following relates to a split bolt assembly and a method for using the split bolt assembly for installation of projects including conductive wire cables.

### BACKGROUND

Global energy consumption continues to increase and most of the energy still comes from fossil-based fuels. While the demand for energy is unlikely to change, the sources of energy are changing, and renewable energy is expected to have a key role. While renewable energy comes in many forms, solar energy has recently become more economically viable even without subsidies. Thus, solar projects are increasing in numbers and scale, bolstered by the recent economic viability.

Solar energy farms consist of numerous rows of photovoltaic (PV) panels mounted to frames. The frames can be stationary or mobile to track the movement of the sun during daylight hours. The photovoltaic panels are electrically connected with taps from the PV panels to run wires and cables. The run wires and cables start at a small gauge at the first PV panel, but as more panels are connected and current needs to be collected, the gauge of the run wires must increase. The tapping method of the PV panel wires to the run wires/cables can vary greatly but there is a current trend toward insulation piercing T-tap connectors with protective housing.

An insulation piercing T-tap connector may be comprised of an insulation piercing T-tap connector and a gel filled clamshell housing with an IP 67 rating for dust and water intrusion. The T-tap portion of the solution is a very common T-tap that has been around for decades with little or no innovation. The T-taps are effective; however, they are very costly and get increasingly more expensive as they become larger in size. The T-tap also requires the gel filled clamshell to pass the IP 67 testing adding to total cost per connection. Thus, while effective, there are real-world disadvantages to the T-tap style tap connectors.

### SUMMARY

According to one non-limiting exemplary embodiment of the present disclosure, a split bolt assembly is provided for coupling two conductive wires. The assembly may comprise a split bolt including a head portion, first threaded leg, a second threaded leg, and a cavity formed between the head portion, the first threaded leg, and the second threaded leg; a piercing blade holder configured to fit within the cavity, the piercing blade holder including a slot, a piercing blade configured to sit into the slot of the piercing blade holder, a reinforcement shim configured to fit within the cavity, and a nut configured to fit and be torqued around the first threaded leg and the second threaded leg, wherein a first cable is configured to fit within the cavity between the head portion and the piercing blade holder, and wherein a second cable is configured to fit within the cavity between the reinforcement shim and the piercing blade holder.

A detailed description of this and other non-limiting exemplary embodiments of a split bolt assembly and method for using such assembly is set forth below together with the accompanying drawings.

### BRIEF DESCRIPTION OF THE DRAWINGS

FIG. 1 illustrates an exploded view of an exemplary split bolt assembly, according to a non-limiting exemplary embodiment of the present disclosure.

FIG. 2 illustrates a perspective view including a partial assembly of the split bolt assembly illustrated in FIG. 1 in an exemplary installation state, according to a non-limiting exemplary embodiment of the present disclosure.

FIG. 3 illustrates a perspective view including a partial assembly of the split bolt assembly illustrated in FIG. 1 in an exemplary installation state, according to a non-limiting exemplary embodiment of the present disclosure.

FIG. 4 illustrates a perspective view including a partial assembly of the split bolt assembly illustrated in FIG. 1 in an exemplary fully installed state, according to a non-limiting exemplary embodiment of the present disclosure.

FIG. 5 illustrates a side view of the split bolt assembly illustrated in FIG. 4 in the exemplary fully installed state, according to a non-limiting exemplary embodiment of the present disclosure.

FIG. 6 illustrates a perspective view of an alternative embodiment of a split bolt assembly, according to a non-limiting exemplary embodiment of the present disclosure.

### DETAILED DESCRIPTION

Detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

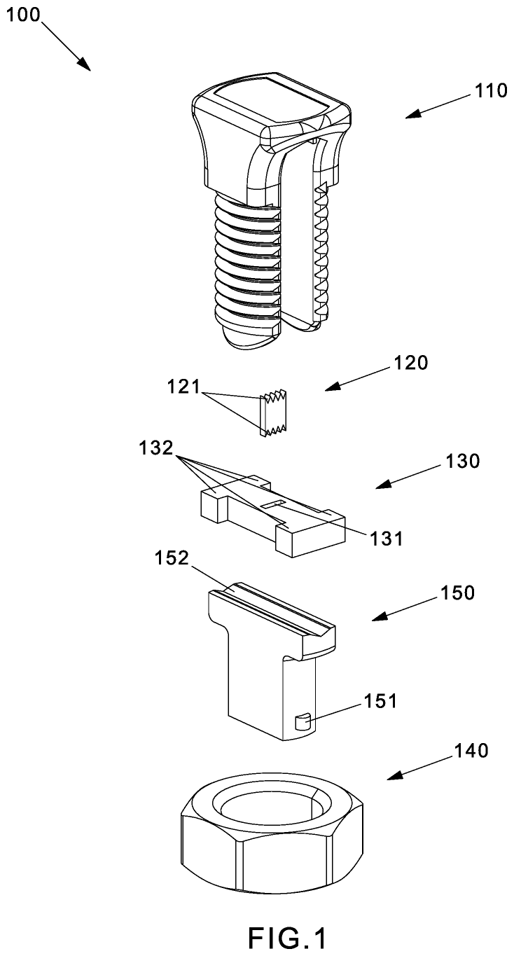

FIG. 1 shows an exploded view of exemplary component pieces that may be included in a split bolt assembly 100. The split bolt assembly 100 includes a split bolt 110, a piercing blade 120, a piercing blade holder 130, a nut 140, and a reinforcement shim 150.

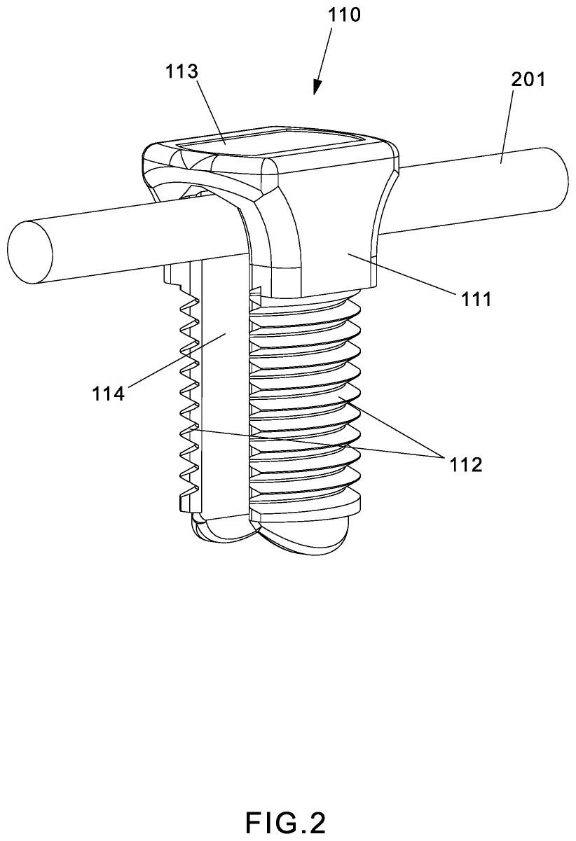

The split bolt 110 may be made from, for example, a non-metallic material such as a glass filled Nylon, or other plastic or polymer material. The split bolt 110 includes a head portion 113 comprising a top side flat surface, as well as flat side surfaces 111 on opposite sides of the head portion 113. The split bolt 110 also includes a pair of threaded legs 112, and a cavity 114 formed between the two threaded legs 112, as shown in FIG. 2.

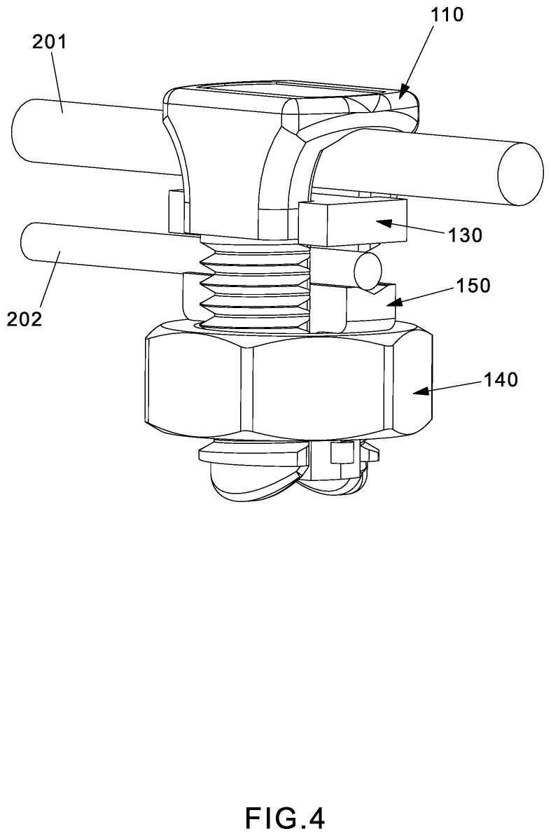

As shown in FIG. 1, the piercing blade 120 is an insulation piercing blade including a set of teeth 121 at a top portion as well as a bottom portion. The piercing blade 120 is made from a conductive material for enabling transmission of electrical currents/signals between a run cable 201 and a tap cable 202 when the set of teeth 121 are pushed through to make contact with a conductive wire in the run cable 201 and the tap cable 202, as shown in FIG. 4.

As shown in FIG. 1, the piercing blade holder 130 includes four protrusions 132 at the four corners to form a “dog bone” shape that enables the piercing blade holder 130 to fit securely in the cavity 114 formed between the two threaded legs 112 of the split bolt 110. A slot 131 is included in a middle portion of the piercing blade holder 130, where the slot 131 is configured to hold the piercing blade 120. The piercing blade holder 130 may be made from a pliable, non-metallic, material such as a plastic, polymer, or compressive foam material. According to other embodiments, the piercing blade holder 130 may be made from a harder material such as a harder plastic or metal material.

As shown in FIG. 1, the nut 140 is configured to be rotatably secured around the two threaded legs 112 of the split bolt 110. The nut 140 includes flat surfaces (e.g., hexagon nut including six flat sides) for enabling a tool to twist the nut 140 around the two threaded legs 112 of the split bolt 110 to move the nut 140 up (e.g., tighten) or down (e.g., loosen/remove) the two threaded legs 112 of the split bolt 110.

As shown in FIG. 4, the reinforcement shim 150 is configured to fit within the cavity 114 formed between the two threaded legs 112 of the split bolt 110 and is included to keep the two threaded legs 112 from moving or being pushed into the cavity as the nut 140 moves to tighten the assembly of components held within the cavity 114. As shown in FIG. 1, the reinforcement shim 150 includes latches 151 on opposite sides to keep the reinforcement shim 105 loosely housed within the nut 140. The reinforcement shim 150 also includes a compression surface 152 that is provided in a concave shape to guide/receive the tap cable 202 as the tap cable 202 is pushed upwards within the cavity 114 to be pierced by the lower teeth in the piercing blade 120.

The split bolt assembly 100 may be pre-assembled at the factory with the nut 140 installed on the split bolt 110 as shown, for example, in FIG. 4. During an installation process using the split bolt assembly 100, an installer may disassemble the split bolt assembly 100 by first removing the nut 140 from the two threaded legs 112, then removing the reinforcement shim 150 from within the cavity 114, and then removing the piercing blade holder 130 from the cavity 114.

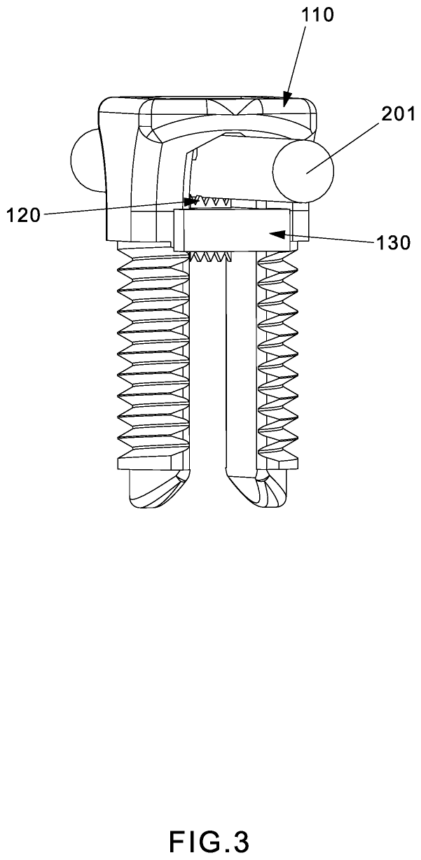

Then to utilize the split bolt assembly 100 to tap together the run cable 201 to the tap cable 202, the installer may first place the split bolt 110 placed over the run cable 201 as shown in FIG. 2. Then the piercing blade holder 130, including the piercing blade 120, is reinstalled into the cavity 114 as shown in FIG. 3. Then the tap cable 202 is placed under the piercing blade holder 130, and then the reinforcement shim 150 is brought up the cavity 114 to support underneath the tap cable 202. Finally, the nut 140 is rotated up the two threaded legs 112 to tighten the components held within the cavity 114. The nut 140 may initially be tightened by hand, after which tools (e.g., Wrenches) may be used to hold onto the flat side surfaces 111 and/or the nut 140 so that the nut 140 may be rotated and tightened up the two threaded legs 112 to the proper torque to have the piercing blade 120 pierce the insulation of the run cable 201 and the tap cable 202 and contact the conductive wire within the run cable 201 and the tap cable 202 to provide the electrical connection between the run cable 201 and the tap cable 202.

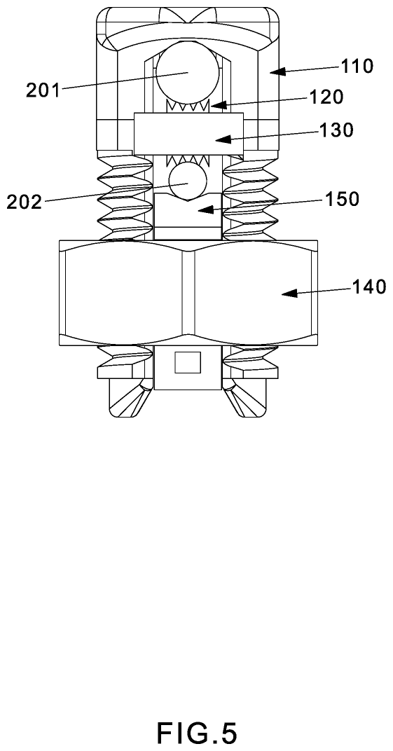

FIG. 5 shows a side view of the split bolt assembly 100 in a fully assembled state where the nut 140 has been rotated and tightened up the two threaded legs 112 to provide the proper torque for having the piercing blade 120 pierce the insulation of the run cable 201 and the tap cable 202 to contact in the conductive wire within the run cable 201 and the tap cable 202 to provide electrical connection between the run cable 201 and the tap cable 202.

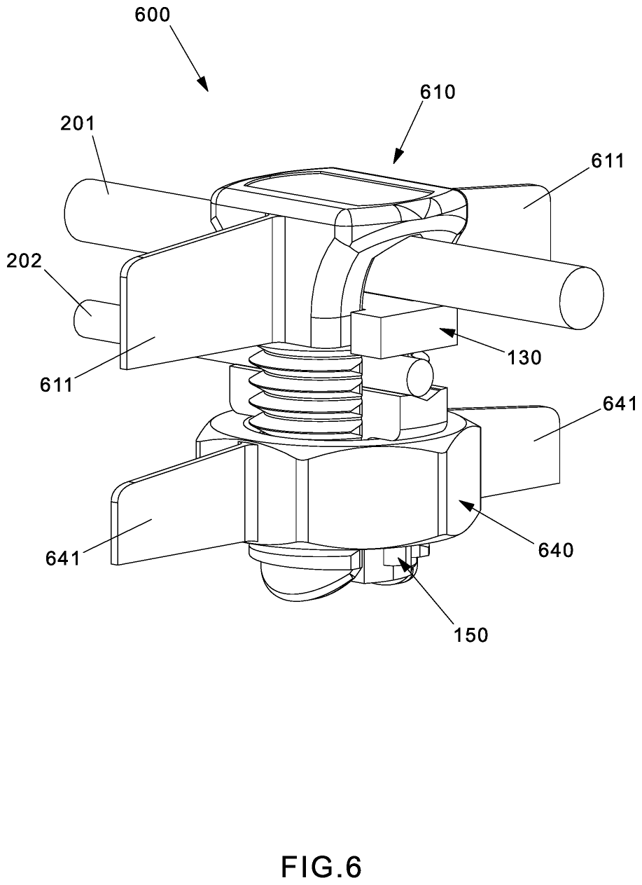

FIG. 6 shows a perspective view of a split bolt assembly 600 according to an alternative embodiment. In the split bolt assembly 600, some of the components such as the piercing blade holder 130, the piercing blade 120 (not specifically illustrated in FIG. 6), and the reinforcement shim 150 may be the same as included in the split bolt assembly 100. However, the split bolt assembly 600 includes a different design for a split bolt 610 and a nut 640. The split bolt 610 shares the same component features from the split bolt 110, however the split bolt 610 includes wings 611 that extend out from the flat side surfaces 111. The nut 640 shares the same component features from the nut 140, however the nut 640 includes wings 641 that extend out from opposite side flat surfaces as shown in FIG. 6. The wings 611 and wings 641 are included in the split bolt assembly 600 to enable toolless installation. An installer may place their fingers on the wings 611 of the split bolt 610 with one hand and the wings 641 of the nut 640 with the other hand, and then apply torque to the assembly to drive the piercing blade 120 through the insulation on each of the run cable 201 and the tap cable 202 to provide electrical connection between the run cable 201 and the tap cable 202.

As is readily apparent from the foregoing, various non-limiting exemplary embodiments of a split bolt assembly have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A split bolt assembly comprising:
a split bolt including a head portion, first threaded leg, a second threaded leg, and a cavity formed between the head portion, the first threaded leg, and the second threaded leg;
a piercing blade holder configured to fit within the cavity, the piercing blade holder including a slot;
a piercing blade configured to sit into the slot of the piercing blade holder;
a reinforcement shim configured to fit within the cavity; and
a nut configured to fit and be torqued around the first threaded leg and the second threaded leg, wherein a first cable is configured to fit within the cavity between the head portion and the piercing blade holder, and wherein a second cable is configured to fit within the cavity between the reinforcement shim and the piercing blade holder.

2. The split bolt assembly of claim 1, wherein the reinforcement shim comprises a concave shaped compression surface configured to receive the second cable.

3. The split bolt assembly of claim 1, wherein the split bolt is made from a non-metallic material.

4. The split bolt assembly of claim 1, wherein the split bolt further comprises at least one wing extending from the head portion.

5. The split bolt assembly of claim 1, wherein the nut further comprises at least one wing, the at least one wing extending from a flat portion included on the nut.

6. The split bolt assembly of claim 1, wherein the reinforcement shim further comprises at least one latch.

7. The split bolt assembly of claim 1, wherein the piercing blade holder includes four protrusions to form a dog bone shape.

8. The split bolt assembly of claim 1, wherein the nut is configured to be torqued around the first threaded leg and the second threaded leg until the piercing blade pierces a first insulation jacket of the first cable and a second insulation jacket of the second cable to provide an electrical coupling between the first cable and the second cable.

9. The split bolt assembly of claim 1, wherein the head portion includes a first side flat surface and a second side flat surface.

10. The split bolt assembly of claim 1, wherein the head portion includes a top side flat surface.
